(19) United States
(12) Patent Application Publication
(10) Pub. No.: US 2022/0309136 A1
(43) Pub. Date: Sep. 29, 2022

(54) Contactless Palm Scanner

(71) Applicant: Chivalry Health Inc., Fremont, CA (US)

(72) Inventors: Wenxing QUAN, Fremont, CA (US); Alvin Zijun YU, Neward, CA (US)

(73) Assignee: Chivalry Health Inc., Fremont, CA (US)

(21) Appl. No.: 17/211,637

(22) Filed: Mar. 24, 2021

(51) Int. Cl. G06F 21/32; H04L 29/06

(52) U.S. Cl. CPC G06F 21/32; H04L 63/0861

(57) ABSTRACT

Present invention teaches a contactless palm scanner made up of an optical scanning unit, distance sensor, lights, air vent, and a speaker housed in a main body where the desired. controlling logic, implemented in a programmable logic means, will guide a person's hand to approach the device and, with light and sound cues, direct the palm to the right location for the scan and recognition against information in a stored database, all done without causing the hand/palm to make physical contact with the device.

### FIELD AND BACKGROUND OF THE INVENTION

Scanning devices, oftentimes used as a means of entry control in corporate setting or government administration, usually require some form of physical contact. For example, finger-print scanning in certain bio- or medical-lab settings requires a person to place the fingers on a piece of glass, or some flat surface, for the scanning to work.

Retina scanning similarly requires a person to put the facial skin in contact with a frame or a ring for the scanning unit to properly scan the retina pattern in a person's eye.

There are always health concerns for this type of “contact in order to scan” setup. The concerns are especially poignant in a pandemic context.

Present invention disclosed a contactless palm-scanning device with visual and audio cues to guide a person into placing the hand, specifically the palm portion, towards the device for scanning and recognition and checked against the personnel information stored on a database, either a local database stored in a memory chip that resides within the present scanning device, or a remote database connected via network.

Implemented via the controlling logic, and with the use of the lights, sensors and air bursts from the vent, a human hand will never need to physically come into contact with the scanning device, greatly enhancing the health and hygiene of the operation, especially in a pandemic context.

### SUMMARY OF THE INVENTION

The invention relates to a palm-scanning device that requires no physical contact between the unit and the human hand, greatly reducing the health concerns especially during a pandemic or presence of contagious diseases.

The palm-scanning device of present application is comprised of a main body having an upward central opening. An optical scanning unit is located at the bottom of the central opening, providing a scanning pattern towards the direction of the opening.

A plurality of lights are located around top peripheral edge of the main body. The lights can be of the same color or different colors, depending on intended applications as programmed by users based upon specific needs. At least one distance sensor is located around top peripheral edge of the main body.

Alternatively, the at least one distance sensor can also be placed at the bottom of the central opening, adjacent to the optical scanning unit.

At least one speaker unit is embedded into the side of the main body. The speaker can make sounds, as controlled by the system, through some holes on the side to give a person the notice reminder or signal as to hand movement.

There is a vent, around the top edge of the main body, that can emit a gentle burst of air as a notice/signal to a person, signaling the proper time to stop hand/palm movement and ready to withdraw as prompted.

The palm-scanning device of present application will operate in way to cause a. person's palm to reach towards the main body, guided by the lights and the speaker, as well as additional signaling from the vent, resulting in the palm to be scanned and recognized by the scanning unit when the palm is at an appropriate distance from the scanning unit.

The scanned and recognized palm pattern will be checked against either a local database containing personnel information, implemented either as a memory chip inside the main body, or as a remote database accessible via network connection.

The controlling logic, implementing the operation of the palm-scanning device, as reflected in the flow chart, can be implemented by means of a memory chip that allows easy editing, updating, or changing, to fit different application parameters and patterns.

### DESCRIPTION OF THE DRAWINGS

The accompanying drawings exemplify the preferred embodiments of the invention. Together with the description, serve to explain the principles of the invention.

A brief description of the drawings is as follows:

FIG. 1 is the perspective view of the primary structure of present invention.

FIG. 2 shows the main body with indication of lights on and air coming out from air vents.

FIG. 3 shows the top-down view of the main structure with distance sensor unit located at the inside of the well area and the optical scanning unit in the middle of the well area.

FIGS. 4-6 show a hand/palm moving towards the device at different distances.

FIG. 7 shows the control flow chart of the system operation.

FIG. 8 shows the control flow chart of the system operation with air burst function added.

### DETAILED DESCRIPTION OF THE PREFERRED EMBODIMENT

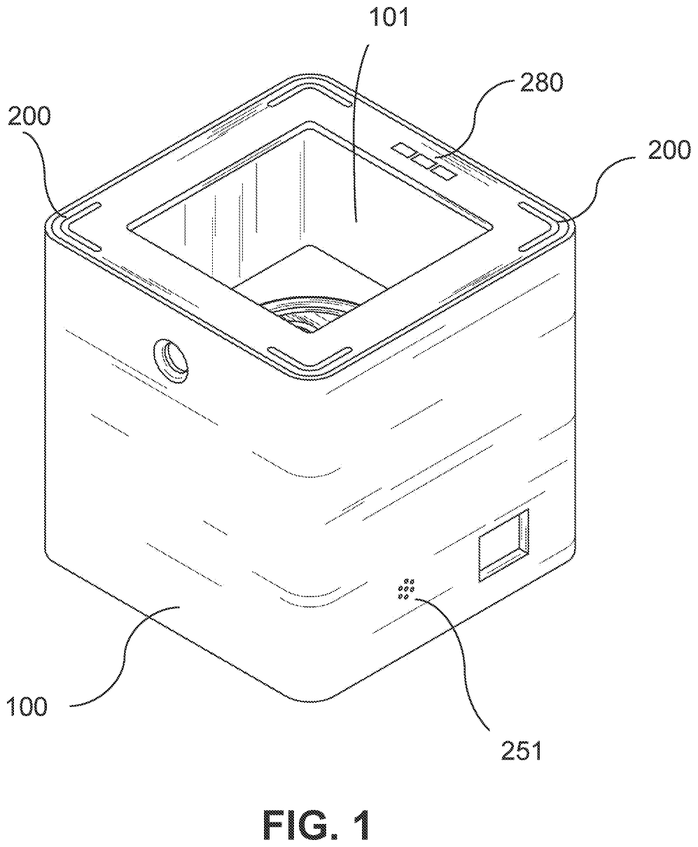

The contactless palm scanner of present application is comprised of a main body 100 with an upward central opening 101, as shown in FIG. 1.

A vent 280 is located around the top edge of the main body 100. The embodiment of the vent 280 can be made to consist of several openings, as shown in FIG. 1.

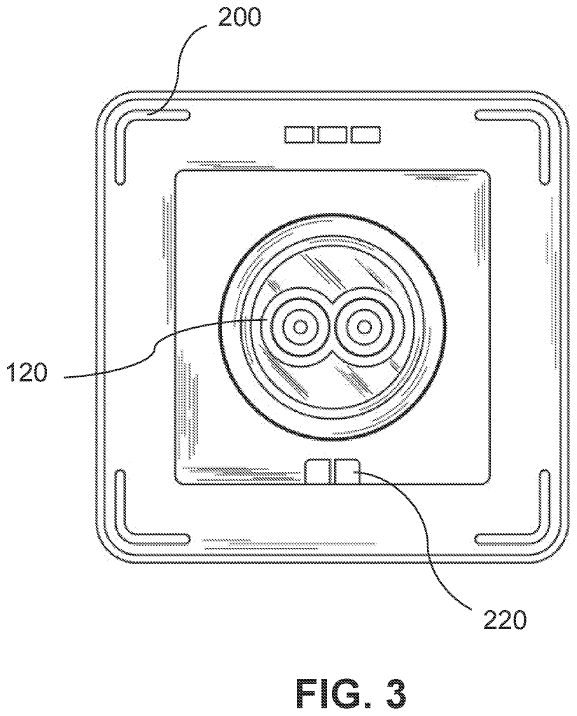

An optical scanning unit 12.0 is located at the central opening 101. The top-down view presented in FIG. 3 shows the optical scanning unit 120.

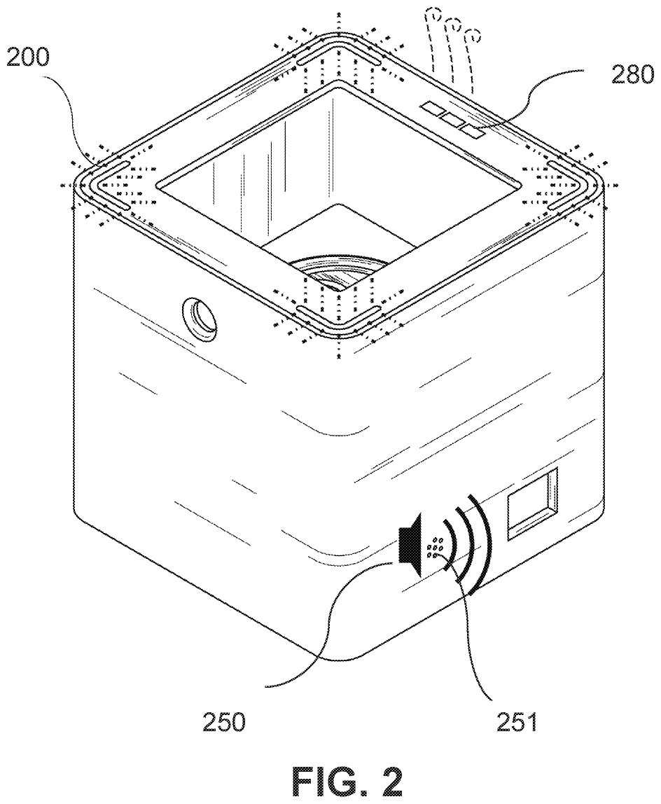

A plurality of lights 200 are located around top peripheral edge of the main body 100, as shown in FIG. 2. The lights 200 can be of the same color or different colors, depending on intended applications as programmed by equipment providers or users based upon specific design parameters or environmental needs.

At least one distance sensor 220 is located in the main body 100, One of the preferred embodiments is to put the at least one distance sensor 220 at the bottom of the central opening 101, at approximately the same level as the optical scanning unit 120.

Certainly, the at least one distance sensor 220 can be located elsewhere on the main body 100, such as around the top edge at the same level as the vent holes 280.

Certainly, the measurement of distance from the sensor 220 to a human palm will be done differently based upon the location being set on the top edge of the main body 100, or at the bottom of the central opening 101, or other locations as may be implemented by a person reasonably skilled in the art in addition to the two locations stated herein.

At least one speaker unit 250 is embedded into the side of the main body 100.

Some holes 251 are made around the side of the main body 100, to allow the sound of the speaker unit 250 to be emitted out. A person of reasonable skill in the art will know how to place the speaker unit 250 on the main body 100, relative to the location of the holes 251, even though the drawings did not specifically set forth the location of the speaker 250.

The plurality of lights 200 and the speaker 250 are controlled by programmable logic means 300 to guide a person's palm to be at an appropriate distance, as indicated by the distance sensor 220, to perform the scanning and recognizing action.

The vent 280 can emit a gentle burst of air as a notice/signal to a person, signaling the proper time to stop hand/palm movement and ready to withdraw as prompted.

The specific notice/signal represented by the burst of air from the vent 280 is subject to change based upon varying application by different people when using the palm scanner of present invention.

The palm scanner of present application will operate in a way that, when a person's palm is reaching down towards the main body 100, and as guided by the lights 200 and beeping sound made by the speaker 250, as well as additional signaling from the vent 280, resulting in the palm to be scanned and recognized by the scanning unit 120 when the palm is at an appropriate distance from the scanning unit 120.

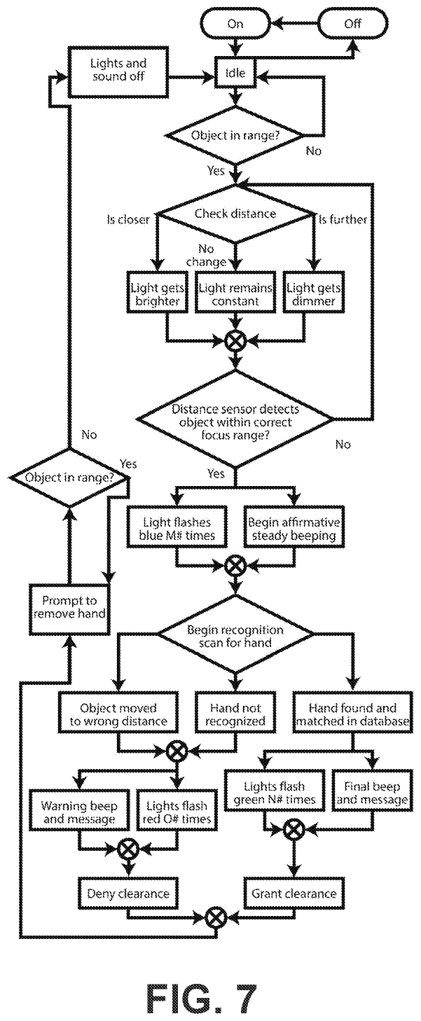

The controlling logic for the operation of the device is shown in the flow chart of FIG. 7. As indicated, once the system is on, it goes into an “idle loop until it detects an object (a hand or palm) is in range. Then it goes down the control logic of checking proper distance, using changing lights to guide and sound as cue to indicate the right distance to start scanning and recognition,

Once a palm is in range, the distance sensor 220 will cause the lights 200 to go brighter or dimmer, depending on the distance sensed, to guide the palm movement to an appropriate distance.

Once the palm is held at the right distance, the lights 200 will show full brightness; the speaker 250 will emit out an affirmative beeping sound, or other clear audible cue, for the scanning unit 120 to scan the recognize the palm pattern.

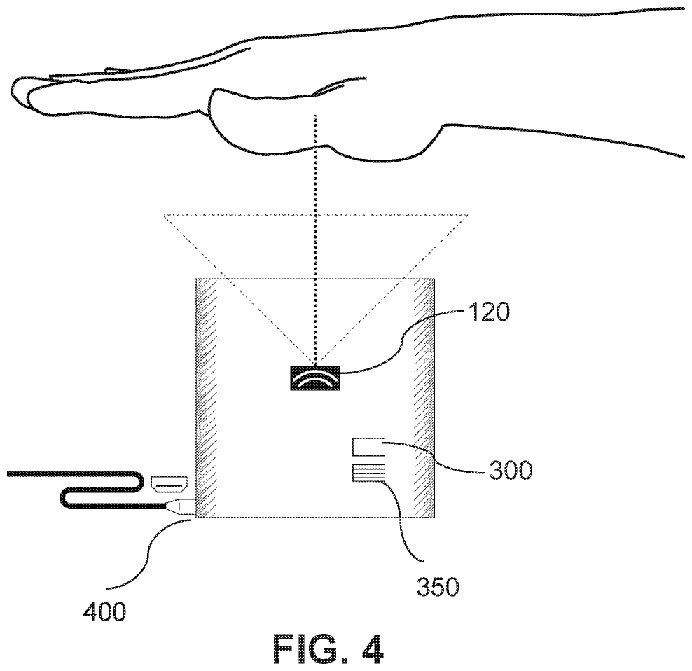

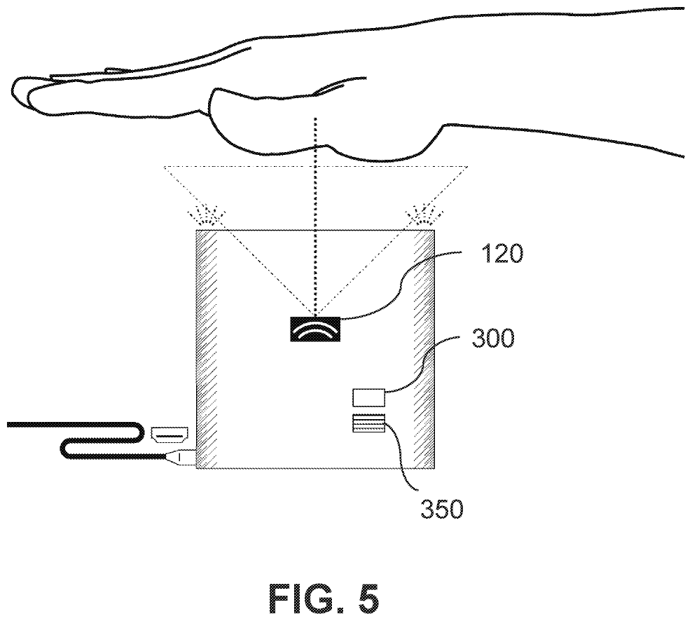

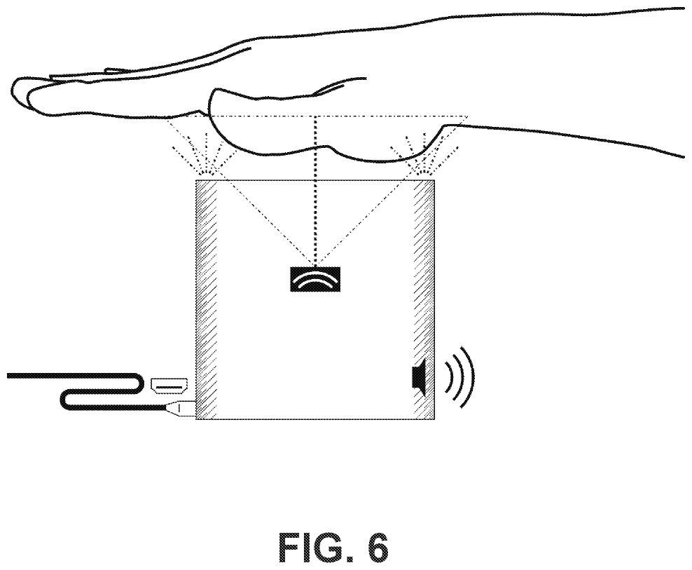

See FIGS. 4-6, providing conceptual movement guidance.

Once the recognition is made, either against a local database residing on a memory chip 350 of the main body 100, or against a remote database connected via a network interface 400, a completion of scan signal, such as red lights emitted by the lights 200 and/or different beeping pattern from the speaker 250, will remind a person to tee remove the palm, and the palm scanner will return/loop back to the initial idle status to wait for next round of palm-scanning operation.

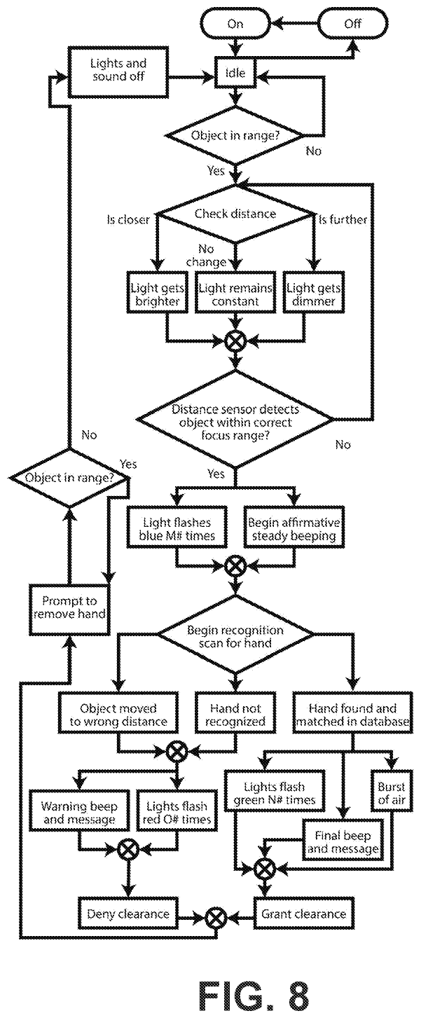

At completion of scan and recognition, additionally, the vent 280 can send out a burst of air to remind a person to remove the palm away; this additional burst of air feature is shown in the flow chart of FIG. 8.

The controlling logic, as represented in the FIGS. 7 and 8 flow charts, is implemented by a programmable logic means 300 that can take the form of a digital or computer programmable chip or suitable microprocessor unit that allows user programming for updating of operating parameters to change the sensing, lighting and sounding patterns. A person ordinarily skilled in the art will be able to use commercially available such chip or microprocessor and to alter, change, update or otherwise edit the content of the controlling logic, to effectuate different sensing, lighting, and sounding patterns, as desired to fit varying applications.

The contactless palm scanner further can contain a database memory chip 350 within the main body to store personnel information to compare against scanned and recognized palm information.

The contactless palm scanner further can contain a network interface 400 for connecting to remote database of personnel information via commercially available network connection.

The interface 400 shown herein is an embodiment of wired connection type. Various commercial embodiments of wireless interfaces, such as those conforming to WiFi standards, can be implemented to achieve networking purpose, without plugging in any wired connector, such as USB or RJ-45, or any other wired communication protocol. These implementations are known to a PORTA and are commercially available, thus require no disclosure herein.

The teachings presented herein are the preferred and exemplary embodiments of the invention as disclosed. Further modifications and improvements will be readily apparent to those skilled in the art. The scope and spirit of the present invention is not to be limited the embodiments herein, but is to be understood in the broadest sense allowed by law commensurate with the disclosure of this application.

1. A contactless palm scanner comprising
A main body with a central opening;
An optical scanning unit located at the bottom of the central opening;
A plurality of lights located around top peripheral edge of the main body;
At least one distance sensor located in the main body; and
At least one speaker unit embedded into the side of the main body;
where the plurality of lights and the speaker are controlled by programmable logic means to guide a person's palm to be at an appropriate distance, as indicated by the distance sensor, to perform the scanning and recognizing action.

2. The contactless palm scanner of claim 1 wherein the at least one distance sensor is located around the top peripheral edge of the main body.

3. The contactless palm scanner of claim 1 wherein the at least one distance sensor is located at the bottom of the central opening.

4. The contactless palm scanner of claim 1 further comprising at least a vent around top peripheral edge of the main body.

5. The contactless palm scanner of claim 1 where the programmable logic means consists of a computer programmable unit or suitable microprocessor unit that allows user programming for updating of operating parameters to change the sensing, lighting and sounding patterns.

6. The contactless palm scanner of claim 1 further comprising a database memory chip within the main body to store personnel information to compare against scanned and recognized palm information.

7. The contactless palm scanner of claim 1 further has a network interface for connecting to remote database of personnel information via commercially available network connection.
